(19) United States
(12) Patent Application Publication
(10) Pub. No.: US 2010/0326754 A1
(43) Pub. Date: Dec. 30, 2010

(54) METHOD OF HYBRID VEHICLE ENGINE START USING STORED KINETIC ENERGY

(76) Inventor: J. Axel Radermacher, Foothill Ranch, CA (US)

Correspondence Address: BUTZEL LONG;IP DOCKETING DEPT, 350 SOUTH MAIN STREET, SUITE 300, ANN ARBOR, MI, 48104, US

(21) Appl. No.: 12/823,329

(22) Filed: Jun. 25, 2010

Related U.S. Application Data
(60) Provisional application No. 61/220,397, filed on Jun. 25, 2009.

(51) Int. Cl. B60W 20/00; B60W 10/00

(52) U.S. Cl. 180/65.265

(57) ABSTRACT

A system and method for starting an engine on a hybrid vehicle includes a motor and an engine coupled to the motor using a clutch. An electrical energy storage device is operatively connected to the motor. The engine is started by decoupling the motor from the engine, and supplying electrical energy from an electrical energy storage device to operate the motor until the motor attains a predetermined speed. The motor is coupled to the engine to transfer kinetic energy from the motor to the engine, and the transferred kinetic energy is used to start the engine.

### CROSS REFERENCE TO RELATED APPLICATIONS

This application claims the benefit of and priority to U.S. Provisional Application 61/220,397, filed Jun. 25, 2009, which is incorporated herein by reference.

### BACKGROUND

The present disclosure relates generally to a hybrid vehicle, and more particularly to a method of starting a hybrid vehicle using stored kinetic energy.

### DESCRIPTION OF THE RELATED ART

Vehicles, such as a motor vehicle, utilize an energy source in order to provide power to operate a vehicle. While petroleum based products dominate as an energy source, alternative energy sources are available, such as methanol, ethanol, natural gas, hydrogen, electricity, solar or the like. A hybrid powered vehicle utilizes a combination of energy sources in order to power the vehicle. Such vehicles are desirable since they take advantage of the benefits of multiple fuel sources, in order to enhance performance and range characteristics of the hybrid vehicle relative to a comparable gasoline powered vehicle.

An example of a hybrid vehicle is a vehicle that utilizes electric and gasoline energy as a power source. An electric vehicle is environmentally advantageous due to its low emissions characteristics and general availability of electricity as a power source. However, battery storage capacity limits the performance of the electric vehicle relative to a comparable gasoline powered vehicle.

For a hybrid vehicle that relies on electrical power, under certain operating conditions the battery may produce minimal or no useable power. An example of such an operating condition is when there is a low state of charge, or at an extremely low battery or ambient temperature or the like. As a result, it may be extremely difficult to start an engine included on the vehicle as an auxiliary power source. Thus, there is a need in the art for a hybrid electric powered vehicle with an improved method of starting the vehicle that utilizes stored kinetic energy to assist in starting the vehicle.

### SUMMARY

Accordingly, the present disclosure relates to a hybrid electric vehicle. The vehicle includes an engine, and a motor coupled to the engine via a clutch mechanism. The vehicle also includes an energy storage device. The vehicle also includes a control module operatively connected to the motor, the engine, the electrical energy storage device, and the clutch. The control module monitors the motor and determines if a predetermined condition has been met, and controls the operation of the clutch such that the clutch is closed when the predetermined condition has been met to transfer kinetic energy from the motor to the engine to start the engine.

Also provided is a method of starting a hybrid electric vehicle using stored kinetic energy. The method of starting the engine includes the steps of de-coupling the motor from the engine using the clutch mechanism. A relatively small amount of power is supplied to the motor to accelerate the motor until a predetermined speed is attained. The motor is coupled to the engine using the clutch and the engine is cranked using the kinetic energy from the rotating motor.

An advantage of the present disclosure is that a method of starting an engine using stored kinetic energy is provided. Another advantage of the present disclosure is that the method of starting the engine improves engine starting under various operating conditions, including low state of charge or extreme temperature. A further advantage of the present disclosure is that the energy storage device is the low voltage battery. Still a further advantage of the present disclosure is that the energy storage device is the high voltage battery. Yet a further advantage of the present disclosure is that a reduced amount of electrical power is utilized to start the engine.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of a hybrid vehicle, according to an exemplary embodiment.

FIG. 2 is a block diagram of a hybrid vehicle architecture having a motor and an engine.

FIG. 3 is a block diagram of another example of a hybrid vehicle architecture having a motor, engine and transmission.

FIG. 4 is another example of a hybrid vehicle architecture having a generator and motor.

FIG. 5 is a flowchart of a method of starting an engine using stored kinetic energy.

### DESCRIPTION

Referring to FIGS. 1-5, a hybrid vehicle 5 and hybrid vehicle architecture 10 is illustrated. In this example the vehicle 5 is a plug-in hybrid vehicle that is gasoline and electric powered. The architecture design 10 can be used in any type of vehicle including passenger vehicles, trucks, heavy duty trucks, off road equipment, or any type of vehicle whereby the engine is connected to a motor and the motor can be de-coupled from the engine via a clutch. The architecture can also be used in industrial machines where an engine is coupled to a generator.

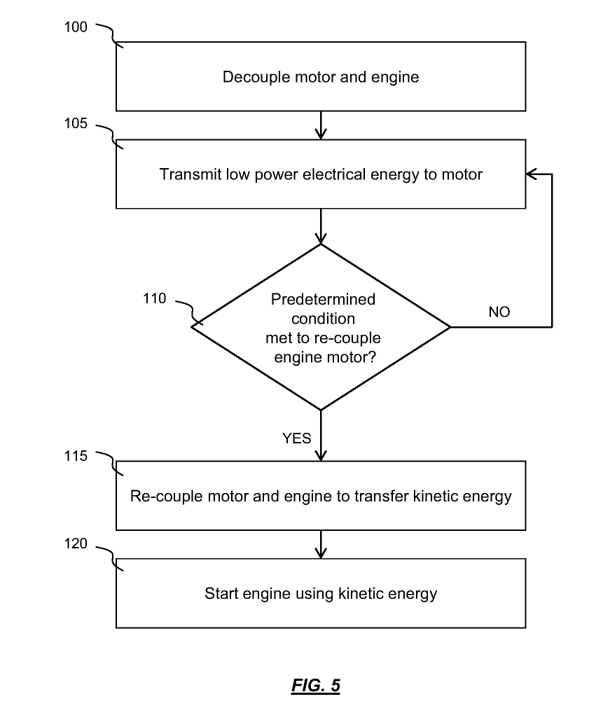

The vehicle architecture 10 also includes a power train that controls movement of the vehicle 5. In this example, the power train is a plug-in hybrid, and includes an electric machine 12, such as an electrically powered motor and motor controller. An example of an electric drive motor is a generator such as a permanent magnet synchronous machine. For example, the motor 12 includes a housing, a stator disposed in the housing that is stationary, and a rotor that rotates about a central shaft and a permanent magnet. The motor 12 includes a rotatable output shaft, and the rotation of the output shaft is applied to the wheels of the vehicle 20 to control movement of the vehicle 5. The motor 12 may also act primarily as a generator and provide electrical power to the wheels 20 through a dedicated drive motor as shown in FIG. 4.

The vehicle also includes a gasoline powered engine 14 that supplements the power supplied by electric motor 12 when required under certain operating conditions. In this example, the engine 14 is a gasoline internal combustion engine. The engine 14 is operatively in communication with the motor 12 via a clutch 16. An example of a clutch 16 is a wet or dry clutch as is conventional in the art.

A transmission 18 may also be operatively in communication with the motor 12 via the clutch 16. The transmission 18, as is conventional in the art, provides a mechanical linkage between the engine 14, motor 12, clutches 16, 17 and wheels 20, 21. The motor output shaft is operatively connected to the transmission 18 and clutch 17 in order to control movement of the vehicle 5.

The motor 12 is operatively in communication with an electrical energy storage device, such as the battery 22. Various types of batteries are available, such as lead acid, or lithium-ion or the like. It should be appreciated that the vehicle 5 may include more than one type of battery or energy storage device. The battery 22 supplies the power in the form of electricity to operate various vehicle components. In this example, there is a low voltage battery 22b that provides electrical power to vehicle components and a high voltage battery 22a (i.e. 400 V traction battery) that provides electrical power to the electric drive motor 12. The battery 22 may be in communication with a control system that regulates the distribution of power within the vehicle 5, such as to the electric drive motor 12, or a vehicle component or other accessories or the like. In this example, the high voltage battery 22a receives electrical energy from a plug-in source, and the low voltage battery 22b receives electrical energy from the high voltage battery 22a or a solar source in a manner to be described.

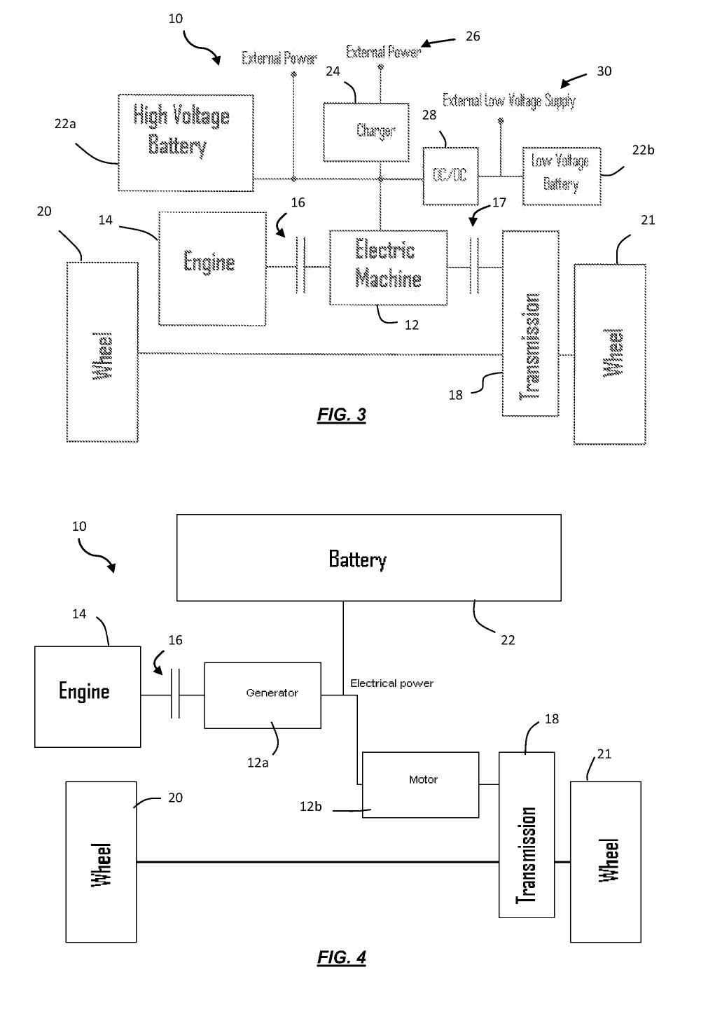

Referring to FIG. 3, another example of a hybrid vehicle architecture 10 is illustrated. In this example, the vehicle architecture 10 also includes a battery charger 24. The battery charger 24 may be in electrical communication with an external power source 26, such as a 120V AC power supply. It should be noted that the battery charger 24 usually converts household power (120V AC) to the DC voltage of the high voltage battery 22a.

The 400V battery 22a is in communication with a power converter. In this example, the power converter is a DC/DC Energy converter 28. The DC/DC energy converter 28 may have bi-directional energy flow capability between the low voltage battery 22a and high voltage battery 22b, depending on factors such as the charge state or starting needs or the like. For example, a DC/DC converter 28 that controls the energy flow between the high voltage battery 22b and the low voltage battery (buck) 22a and between the low voltage battery 22b and the high voltage battery (boost) 22a. The DC/DC energy converter 28 receives current from a low voltage battery 22b, such as a 12 V battery. The DC/DC 28 may also boost current received from an off-board low voltage supply 30 such as during a jump start. The DC/DC 28 can also provide the power to the motor 12 for the method described herein.

The vehicle architecture 10 includes other components, such as a battery electronic control module (BECM) that monitors the status and controls state of charge of the batteries and a hybrid control unit (HCU). The BECM controls the high voltage contactors and the high voltage interlock. The HCU controls the powertrain and may interface with other controllers, such as the vehicle control module (VCM), DC/DC, BECM, or the like. The HCU manages the distribution of power of the high voltage battery charging system 24 and electric motor 12. The vehicle architecture 10 may further include a drive train or the like. Another example of a potential hybrid architecture 10 including a generator 12a and a motor 12b is illustrated in FIG. 4.

Referring to FIG. 5, the method of starting the engine 12 using stored kinetic energy begins in block 100 with the step of de-coupling the motor from the engine using the clutch. The motor may also be de-coupled from another device such as the transmission. The method may be implemented when a predetermined condition is met, such as the battery charge level is below a predetermined level or the battery temperature is below a predetermined temperature such −30° C. or another condition as necessary.

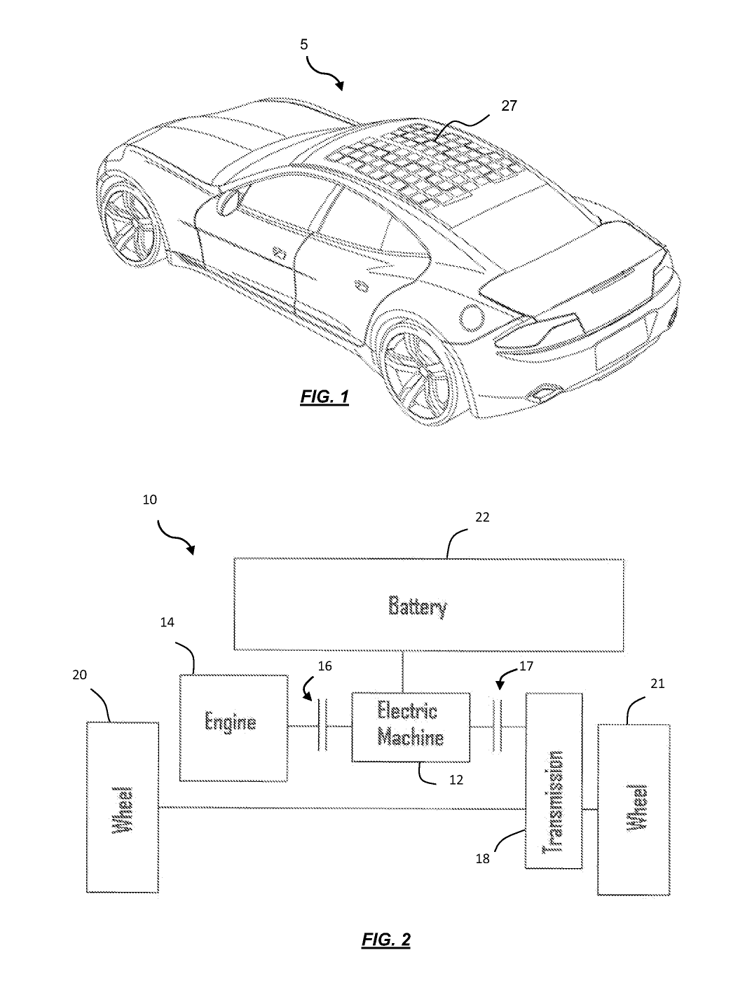

In block 105, stored electrical energy from the electrical energy storage device is transmitted to the motor and used to operate the motor. For example, the electrical energy is used to spin the rotor. It should be appreciated that a minimal amount of energy is utilized to operate the motor. The electrical energy storage device can be a high voltage battery as shown in FIG. 4. In addition, sources other than the high voltage battery can supply the requisite electrical energy, such as the low voltage battery as shown in FIG. 2 (using the DC/DC converter in “boost” mode), or from an outside source, such as a vehicle, a power grid or another charger or the like.

In block 110, it is determined whether a predetermined condition is met to recouple the engine and motor. If the predetermined condition is met, the motor is coupled to the engine. An example of a condition is whether the rotation of the rotor has attained a predetermined critical speed. The critical speed is related to a critical energy level.

In block 115, the clutch is closed to couple the motor to the engine. Kinetic energy stored in the motor is transferred to the engine as the rotation of the rotor slows and the motor decelerates.

In block 120, the engine is started using the kinetic energy received from the motor.

Many modifications and variations of the present disclosure are possible in light of the above teachings. Therefore, within the scope of the appended claim, the present disclosure may be practiced other than as specifically described.

What is claimed is:

1. A system for starting an engine on a hybrid vehicle, the system comprising:
a motor;
an engine coupled to the motor by a clutch;
an electrical energy storage device operatively connected to the motor; and
a control module operatively connected to the motor, the engine, the electrical energy storage device, and the clutch, wherein the control module monitors the motor and determines if a predetermined condition has been met, and controls the operation of the clutch such that the clutch is closed when the predetermined condition has been met to transfer kinetic energy from the motor to the engine to start the engine.

2. The system of claim 1, wherein the predetermined condition is a predetermined motor speed.

3. The system of claim 2, wherein the control module directs electrical energy from the electrical energy storage device to operate the motor until the motor attains a predetermined speed.

4. The system of claim 1, further comprising a battery charger coupled to the motor and in electrical communication with an external power source.

5. The system of claim 1, wherein the electrical energy storage device includes a low voltage battery and a high voltage battery.

6. The system of claim 6, further comprising a power booster in electrical communication with the electrical energy storage device.

7. The system of claim 7, wherein the power booster is a DC/DC converter that monitors the energy flow between the low voltage battery and the high voltage battery.

8. The system of claim 8, wherein the high voltage battery is a 400 V traction battery.

9. The system of claim 1, further comprising a transmission in operative communication with the motor by the clutch.

10. A system for starting an engine on a hybrid vehicle, the system comprising:
an electric machine;
an engine coupled to the electric machine by a clutch;
an electrical energy storage device operatively connected to the electric machine;
a control module operatively connected to the electric machine, the engine, the electrical energy storage device, and the clutch, wherein the control module monitors the electric machine and determines if a predetermined condition has been met, and controls the operation of the clutch such that the clutch is closed when the predetermined condition has been met to transfer kinetic energy from the electric machine to the engine to start the engine wherein the predetermined condition is a predetermined electric machine speed.

11. The system of claim 2, wherein the control module directs electrical energy from the electrical energy storage device to operate the electric machine until the electric machine attains a predetermined speed.

12. The system of claim 1 wherein the engine is started by decoupling the electric machine from the engine by opening the clutch.

13. The system of claim 1, further comprising a battery charger coupled to the electric machine and in electrical communication with an external power source.

14. The system of claim 1, wherein the electrical energy storage device includes a low voltage battery and a high voltage battery.

15. The system of claim 6, further comprising a power booster in electrical communication with the electrical energy storage device.

16. The system of claim 7, wherein the power booster is a DC/DC converter that monitors the energy flow between the low voltage battery and the high voltage battery.

17. The system of claim 8, wherein the high voltage battery is a 400 V traction battery.

18. The system of claim 1, further comprising a transmission in operative communication with the electric machine by the clutch.

19. A method of starting an engine on a hybrid vehicle having a motor coupled to an engine by a clutch, comprising the steps of:
decoupling the motor and engine by releasing the clutch;
transmitting low power electrical energy to the motor;
determining whether a predetermined condition is met;
re-coupling the motor and engine when the predetermined condition is met; and
transmitting kinetic energy from the motor to the engine to start the engine.
